(19) United States
(12) Patent Application Publication
(10) Pub. No.: US 2020/0357064 A1
(43) Pub. Date: Nov. 12, 2020

(54) SYSTEM AND METHOD FOR MANAGING DISTRIBUTED OWNERSHIP OF TANGIBLE ASSETS

(71) Applicant: Nestmarket Inc., Jacksonville, FL (US)

(72) Inventors: Roozbeh Borhani, Saint Johns, FL (US); Jeremy Rosser, Ponte Vedra Beach, FL (US)

(21) Appl. No.: 16/868,694

(22) Filed: May 7, 2020

Related U.S. Application Data
(60) Provisional application No. 62/844,507, filed on May 7, 2019.

(51) Int. Cl. G06Q 40/04; G06F 3/0484; G06Q 50/16

(52) U.S. Cl. CPC G06Q 40/04; G06Q 50/16; G06F 3/04842

(57) ABSTRACT

A method, computer program product, and computer system for receiving, via the computing device, a visual representation of a tangible asset. The visual representation of the tangible asset may be divided into a plurality of portions. The plurality of portions of the visual representation of the tangible asset may be provided to at least one computing device for display within a graphical user interface of the at least one computing device. A user selection of at least one portion of the plurality of portions of the visual representation of the tangible asset may be received from the at least one computing device. The at least one selected portion of the visual representation of the tangible asset may be associated with the user.

### CROSS-REFERENCE TO RELATED APPLICATIONS

This application claims the benefit of U.S. Provisional Application No. 62/844,507, filed on 7 May 2019, the contents of which are incorporated by reference.

### BACKGROUND

For financially valuable tangible assets, such as land, real estate, art, collectibles, etc., ownership is typically facilitated through the whole asset being bought by an individual, partnerships, or other business entities. Without a complex contractual agreement, unassociated individuals or businesses cannot have joint ownership of an asset. Furthermore, those assets, once bought, cannot be owned by other individuals, partnerships, or business entities without buying the whole tangible asset, and only once it's made available for purchase.

Additionally, individuals joining a partnership or business entities in order to purchase a tangible asset, generally retain ownership of a tangible asset as a percentage of ownership stake in the partnership or business entity instead of specific sections or components of a tangible asset.

### BRIEF SUMMARY OF DISCLOSURE

In one example implementation, a method, performed by one or more computing devices, may include but is not limited to receiving, via the computing device, a visual representation of a tangible asset. The visual representation of the tangible asset may be divided into a plurality of portions. The plurality of portions of the visual representation of the tangible asset may be provided to at least one computing device for display within a graphical user interface of the at least one computing device. A user selection of at least one portion of the plurality of portions of the visual representation of the tangible asset may be received from the at least one computing device. The at least one selected portion of the visual representation of the tangible asset may be associated with the user.

One or more of the following example features may be included. Dividing the visual representation of the tangible asset into the plurality of portions may include dividing the visual representation of the tangible asset into a plurality of equal-sized portions. The plurality of equal-sized portions may include a plurality of equal-sized units and a plurality of equal-sized sub-units associated with each equal-sized unit. Dividing the visual representation of the tangible asset into the plurality of portions may be based upon, at least in part, a value of the tangible asset. Associating the at least one selected portion of the visual representation of the tangible asset with the user may include one or more of enabling the user to convey the at least one selected portion of the visual representation of the tangible asset to another user; enabling the user to define a price for the at least one selected portion of the visual representation of the tangible asset; and enabling a user to modify a visual appearance of the at least one selected portion of the visual representation of the tangible asset. A visual indicator for the plurality of portions of the visual representation of the tangible asset indicative of whether each portion of the visual representation of the tangible asset is associated with any user may be provided. One or more user interactions with the plurality of portions of the visual representation of the tangible asset may be monitored. In response to monitoring at least a threshold number of user interactions with a particular portion of the virtual representation of the tangible asset, information associated with the particular portion of the virtual representation of the tangible asset may be preloaded to a computing device associated with the user during a subsequent user interaction with the plurality of portions of the virtual representation of the tangible asset.

In another example implementation, a computing system may include one or more processors and one or more memories configured to perform operations that may include but are not limited to receiving, via the computing device, a visual representation of a tangible asset. The visual representation of the tangible asset may be divided into a plurality of portions. The plurality of portions of the visual representation of the tangible asset may be provided to at least one computing device for display within a graphical user interface of the at least one computing device. A user selection of at least one portion of the plurality of portions of the visual representation of the tangible asset may be received from the at least one computing device. The at least one selected portion of the visual representation of the tangible asset may be associated with the user.

One or more of the following example features may be included. Dividing the visual representation of the tangible asset into the plurality of portions may include dividing the visual representation of the tangible asset into a plurality of equal-sized portions. The plurality of equal-sized portions may include a plurality of equal-sized units and a plurality of equal-sized sub-units associated with each equal-sized unit. Dividing the visual representation of the tangible asset into the plurality of portions may be based upon, at least in part, a value of the tangible asset. Associating the at least one selected portion of the visual representation of the tangible asset with the user may include one or more of enabling the user to convey the at least one selected portion of the visual representation of the tangible asset to another user; enabling the user to define a price for the at least one selected portion of the visual representation of the tangible asset; and enabling a user to modify a visual appearance of the at least one selected portion of the visual representation of the tangible asset. A visual indicator for the plurality of portions of the visual representation of the tangible asset indicative of whether each portion of the visual representation of the tangible asset is associated with any user may be provided. One or more user interactions with the plurality of portions of the visual representation of the tangible asset may be monitored. In response to monitoring at least a threshold number of user interactions with a particular portion of the virtual representation of the tangible asset, information associated with the particular portion of the virtual representation of the tangible asset may be preloaded to a computing device associated with the user during a subsequent user interaction with the plurality of portions of the virtual representation of the tangible asset.

In another example implementation, a computer program product may reside on a computer readable storage medium having a plurality of instructions stored thereon which, when executed across one or more processors, may cause at least a portion of the one or more processors to perform operations that may include but are not limited to receiving a visual representation of a tangible asset, wherein the processor is further configured to divide the visual representation of the tangible asset into a plurality of portions, wherein the one or more processors are further configured to provide the plurality of portions of the visual representation of the tangible asset for display within a graphical user interface of at least one computing device, wherein the one or more processors are further configured to receive, from the at least one computing device, a user selection of at least one portion of the plurality of portions of the visual representation of the tangible asset, and wherein the one or more processors are further configured to associate the at least one selected portion of the visual representation of the tangible asset with the user.

One or more of the following example features may be included. Dividing the visual representation of the tangible asset into the plurality of portions may include dividing the visual representation of the tangible asset into a plurality of equal-sized portions. The plurality of equal-sized portions may include a plurality of equal-sized units and a plurality of equal-sized sub-units associated with each equal-sized unit. Dividing the visual representation of the tangible asset into the plurality of portions may be based upon, at least in part, a value of the tangible asset. Associating the at least one selected portion of the visual representation of the tangible asset with the user may include one or more of enabling the user to convey the at least one selected portion of the visual representation of the tangible asset to another user; enabling the user to define a price for the at least one selected portion of the visual representation of the tangible asset; and enabling a user to modify a visual appearance of the at least one selected portion of the visual representation of the tangible asset. A visual indicator for the plurality of portions of the visual representation of the tangible asset indicative of whether each portion of the visual representation of the tangible asset is associated with any user may be provided. One or more user interactions with the plurality of portions of the visual representation of the tangible asset may be monitored. In response to monitoring at least a threshold number of user interactions with a particular portion of the virtual representation of the tangible asset, information associated with the particular portion of the virtual representation of the tangible asset may be preloaded to a computing device associated with the user during a subsequent user interaction with the plurality of portions of the virtual representation of the tangible asset.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a distributed ownership management process coupled to an example distributed computing network according to one or more example implementations of the disclosure;

FIG. 2 is an example flowchart of a distributed ownership management process according to one or more example implementations of the disclosure;

FIGS. 3-5 are example diagrammatic views of a visual representation of a tangible asset and;

FIG. 6 is an example diagrammatic view of various tables of information associated with tangible assets, users, transactions, and portions or sub-units of a visual representation of the tangible asset, according to one or more example implementations of the disclosure;

FIGS. 7-11 are example diagrammatic views of user interfaces of a distributed ownership management process that allow for the selection and association of/purchase of portions of the visual representation of the tangible asset according to one or more example implementations of the disclosure;

FIGS. 12-13 are example diagrammatic views of user interfaces of a distributed ownership management process that allow a user to modify a visual appearance of a portion of the visual representation of the tangible asset associated with the user according to one or more example implementations of the disclosure;

FIGS. 14-15 are example diagrammatic views of user interfaces of a distributed ownership management process that demonstrate various visual indicators indicative of an ownership/associated status of portions of the visual representation of a tangible asset according to one or more example implementations of the disclosure;

FIGS. 16-18 are example diagrammatic views of user interfaces of a distributed ownership management process that allow a user to purchase a portion of the visual representation of the tangible asset according to one or more example implementations of the disclosure; and

FIG. 19 is an example diagrammatic view of a computer of FIG. 1 according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

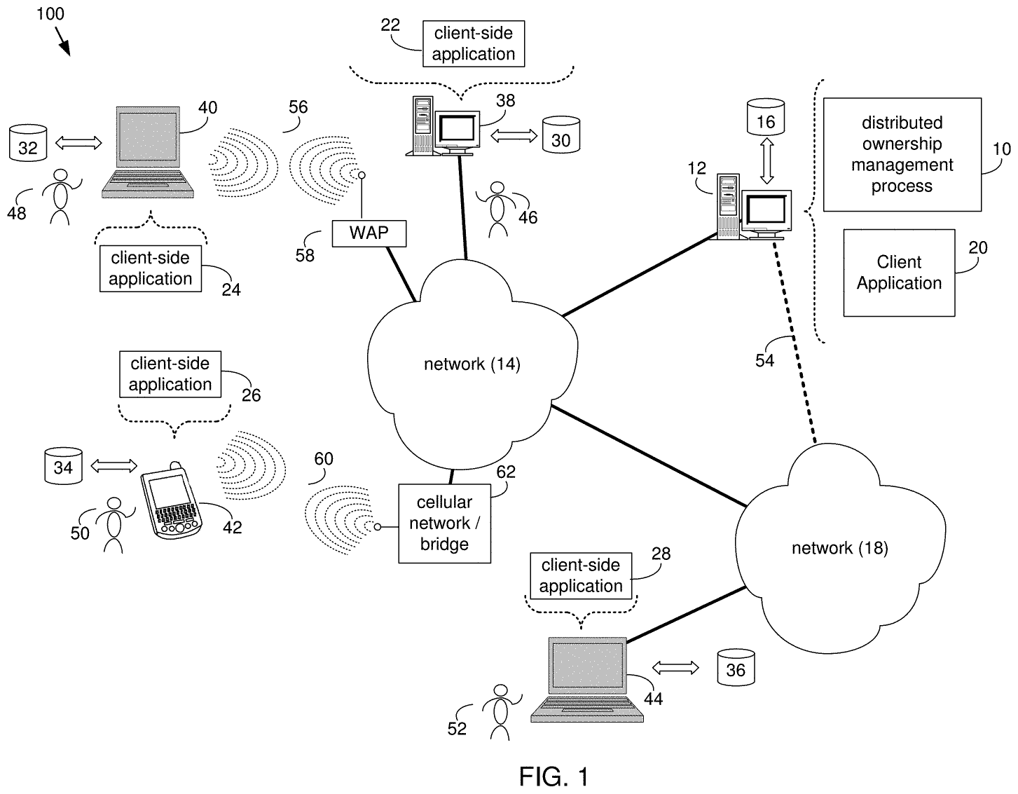

Referring now to the example implementation of FIG. 1, there is shown distributed ownership management process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a distributed ownership management process, such as distributed ownership management process 10 of FIG. 1, may include receiving, via the computing device, a visual representation of a tangible asset. The visual representation of the tangible asset may be divided into a plurality of portions. The plurality of portions of the visual representation of the tangible asset may be provided to at least one computing device for display within a graphical user interface of the at least one computing device. A user selection of at least one portion of the plurality of portions of the visual representation of the tangible asset may be received from the at least one computing device. The at least one selected portion of the visual representation of the tangible asset may be associated with the user.

In some implementations, the instruction sets and subroutines of distributed ownership management process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, distributed ownership management process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a client application (e.g., client application 20). In some implementations, distributed ownership management process 10 and/or client application 20 may be accessed via one or more of client-side applications 22, 24, 26, 28. In some implementations, distributed ownership management process 10 may be a standalone application, or may be an applet/application/script/extension that may interact with and/or be executed within client application 20, a component of client application 20, and/or one or more of client-side applications 22, 24, 26, 28. In some implementations, client application 20 may be a standalone application, or may be an applet/application/script/extension that may interact with and/or be executed within distributed ownership management process 10, a component of distributed ownership management process 10, and/or one or more of client-side applications 22, 24, 26, 28. In some implementations, one or more of client-side applications 22, 24, 26, 28 may be a standalone application, or may be an applet/application/script/extension that may interact with and/or be executed within and/or be a component of distributed ownership management process 10 and/or client application 20. Examples of client-side applications 22, 24, 26, 28 may include, but are not limited to, e.g., a standard and/or mobile web browser, an email application (e.g., an email client application), a textual and/or a graphical user interface, a customized web browser, a plugin, an Application Programming Interface (API), or a custom application. The instruction sets and subroutines of client-side applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client-side applications 22, 24, 26, 28 may be configured to effectuate some or all of the functionality of distributed ownership management process 10 (and vice versa). Accordingly, in some implementations, distributed ownership management process 10 may be a purely server-side application, a purely client-side application, or a hybrid server-side/client-side application that is cooperatively executed by one or more of client-side applications 22, 24, 26, 28 and/or distributed ownership management process 10.

In some implementations, one or more of client-side applications 22, 24, 26, 28 may be configured to effectuate some or all of the functionality of client application 20 (and vice versa). Accordingly, in some implementations, client application 20 may be a purely server-side application, a purely client-side application, or a hybrid server-side/client-side application that is cooperatively executed by one or more of client-side applications 22, 24, 26, 28 and/or client application 20. As one or more of client-side applications 22, 24, 26, 28, distributed ownership management process 10, and client application 20, taken singly or in any combination, may effectuate some or all of the same functionality, any description of effectuating such functionality via one or more of client-side applications 22, 24, 26, 28, distributed ownership management process 10, client application 20, or combination thereof, and any described interaction(s) between one or more of client-side applications 22, 24, 26, 28, distributed ownership management process 10, client application 20, or combination thereof to effectuate such functionality, should be taken as an example only and not to limit the scope of the disclosure.

In some implementations, one or more of users 46, 48, 50, 52 may access computer 12 and distributed ownership management process 10 (e.g., using one or more of client electronic devices 38, 40, 42, 44) directly through network 14 or through secondary network 18. Further, computer 12 may be connected to network 14 through secondary network 18, as illustrated with phantom link line 54. Distributed ownership management process 10 may include one or more user interfaces, such as browsers and textual or graphical user interfaces, through which users 46, 48, 50, 52 may access distributed ownership management process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client-side applications 22, 24, 26, 28 to, e.g., computer 12. Examples of I/O request 15 may include but are not limited to, data write requests (e.g., a request that content be written to computer 12) and data read requests (e.g., a request that content be read from computer 12).

### The Distributed Ownership Management Process:

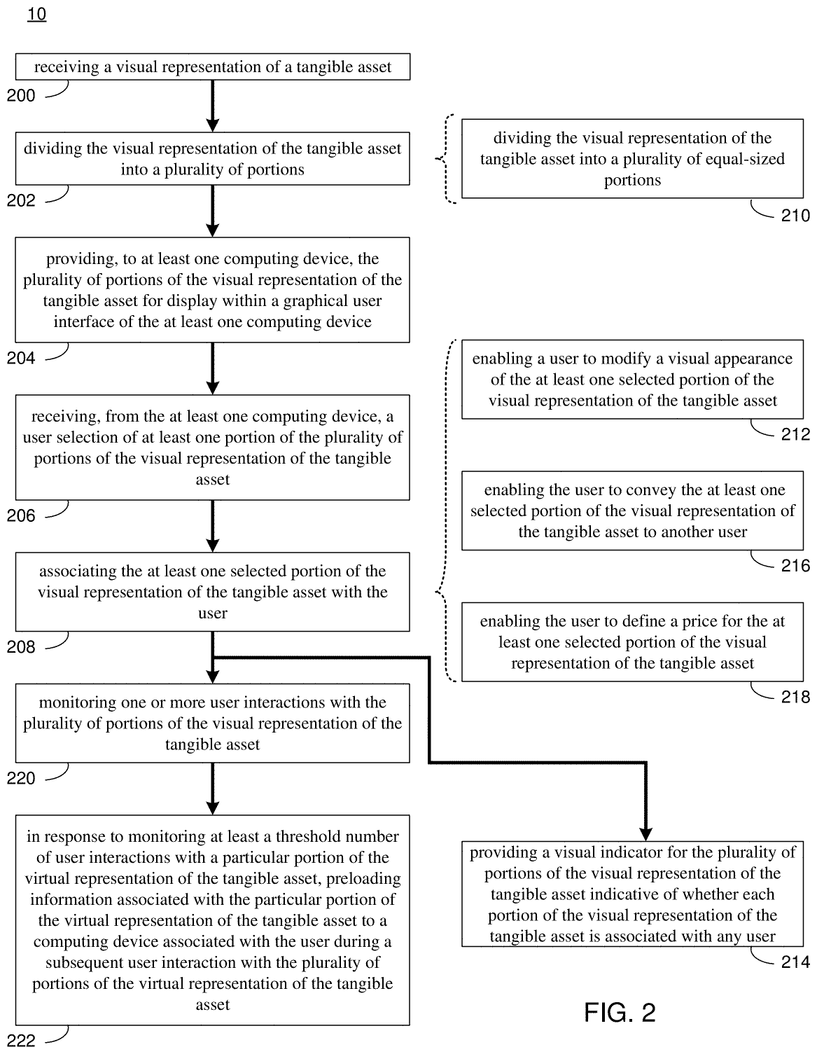

As discussed above and referring also at least to the example implementations of FIGS. 2-19, distributed ownership management process 10 may receive 200, via the computing device, a visual representation of a tangible asset. The visual representation of the tangible asset may be divided 202 into a plurality of portions. The plurality of portions of the visual representation of the tangible asset may be provided 204 to at least one computing device for display within a graphical user interface of the at least one computing device. A user selection of at least one portion of the plurality of portions of the visual representation of the tangible asset may be received 206 from the at least one computing device. The at least one selected portion of the visual representation of the tangible asset may be associated 208 with the user.

As discussed above and in some implementations, implementations of the present disclosure may allow for the management of distributed ownership of tangible assets, which allows consumers to find, purchase, transfer, or sell digital pieces representing a tangible asset, without having to own the entire tangible asset. Distributed ownership may generally refer to associated or non-associated crowdsourcing consumers that may gain co-ownership rights through buying individual digital pieces representing a tangible asset, without entering into contractual agreements with one another.

Conventionally, a tangible asset may generally be owned by an individual or business entity. For an individual or business entity to relinquish ownership of the tangible asset, conventional approaches require listing the whole asset for sale, and once bought, transferring ownership to the new owner, usually through a financial transaction, signing of contracts, and granting direct physical access. This process may preclude tangible assets from being owned by multiple non-associated individuals, unless they form agreements or partnerships under contracts or business entities. Furthermore, to potentially minimize complexity, partnerships and contracts typically represent ownership stake of a tangible asset, as a percentage of the whole asset, instead of specific physical elements, sections, or characteristics of a tangible asset, for each participating owner. As will be discussed in greater detail below, implementations of the present disclosure may allow a tangible asset to be owned by multiple individuals and/or business entities, allow individuals and/or business entities to retain the ability to expediently sell or transfer their ownership rights to other individuals or business entities without having to sell the whole asset, and may allow individuals and/or business entities to select specific sections of a tangible asset to own.

In some implementations, distributed ownership management process 10 may receive 200, via the computing device, a visual representation of a tangible asset. A tangible asset may generally include any physical item. In some implementations, tangible assets may include physical items that may be purchased and owned. In some implementations, distributed ownership management process 10 may receive 200 a visual representation of a tangible asset. A visual representation may generally include an image, at least a portion of a video, a two-dimensional rendering, a three-dimensional rendering, etc. In some implementations, distributed ownership management process 10 may receive 200 the visual representation from a camera, a two-dimensional scanner, a three-dimensional scanner, computer aided design (CAD) software, etc. In some implementations, the visual representation may be uploaded from a client electronic device (e.g., client electronic device 38, 40, 42, 44), a network storage device, a cloud storage device, and/or from the Internet. In some implementations, the visual representation may be a digitalization of the tangible asset. That is, a digital representation of the tangible asset that may be provided digitally to other client electronic devices. In some implementations, the visual representations of the tangible asset may include other features or portions that are not actual components of the tangible asset. For example, suppose a visual representation of an asset is e.g., an image of a house that also includes e.g., a vehicle parked in the driveway of the house. In this example, the tangible asset may include the house and not the vehicle parked in the driveway.

In some implementations and as discussed above, distributed ownership management process 10 may receive 200 the visual representation of a tangible asset. In response to receiving a visual representation, distributed ownership management process 10 may collect (e.g., querying a user or other source of the visual representation) for information about the tangible asset. For example, distributed ownership management process 10 may collect information about the type, size, dimensions, age, value, listing price, previous ownership, legal status, title status, etc. regarding the tangible asset. In some implementations, distributed ownership management process 10 may receive 200 the visual representation of tangible asset and provide (e.g., via a user interface) a rendering of the visual representation for user confirmation. In some implementations, distributed ownership management process 10 may allow a user to modify the visual representation to improve the identification of the tangible asset. For example, distributed ownership management process 10 may provide various options (e.g., within a user interface) for a user to modify the visual representation (e.g., cropping controls, magnification controls, annotation controls, etc.). In this manner, a user may identify a tangible asset in the visual representation received 200 by distributed ownership management process 10.

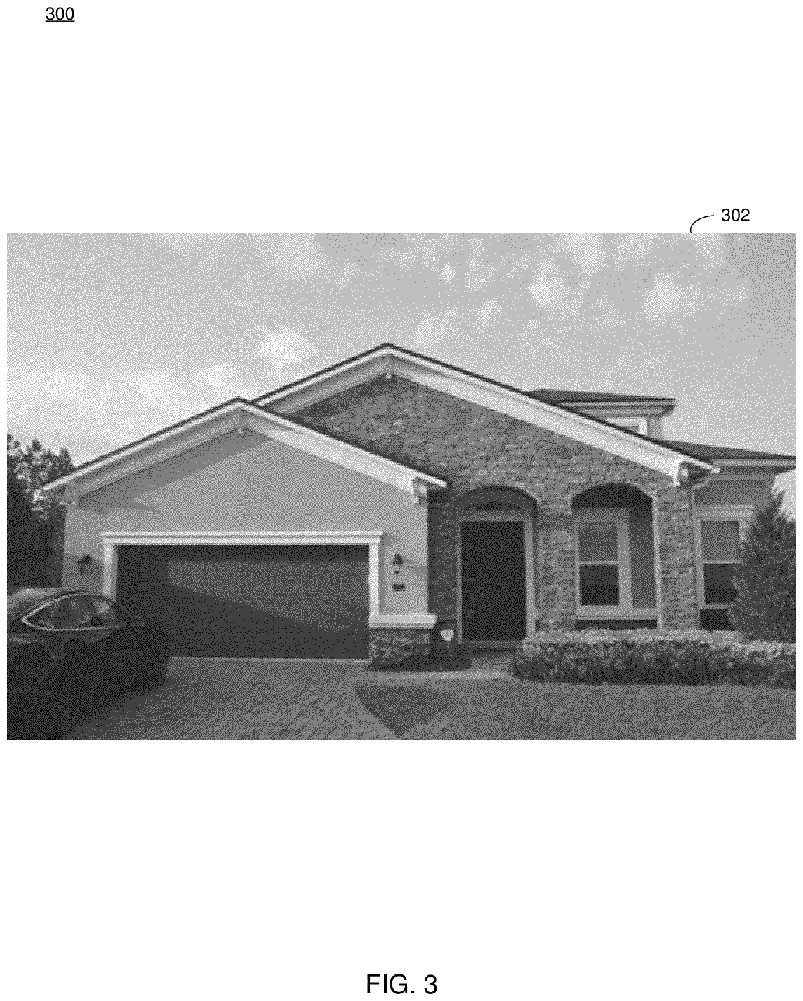

In some implementations and referring also to the example of FIG. 3, distributed ownership management process 10 may receive 200 a visual representation (e.g., visual representation 302) of a e.g., single-family residential house. In this example, distributed ownership management process 10 may collect information associated with the tangible asset (e.g., an estimated market value of $375,000). While an example of a house has been provided for a tangible asset and an image of the house for the visual representation of the tangible asset, it will be appreciated that any tangible asset and/or visual representation may be used within the scope of the present disclosure.

In some implementations, distributed ownership management process 10 may divide 202 the visual representation of the tangible asset into a plurality of portions. For example and in some implementations, the visual representation (e.g., digitized version) of a tangible asset is divided 202 into a plurality of portions. In some implementations, these portions may be referred to as units. In some implementations, the plurality of portions may be equal-sized or may vary in size. For example, in some implementations, how the visual representation of the tangible asset is divided 202 may be based upon, at least in part, the type of tangible asset and/or the type of visual representation. In one example, a three-dimensional visual representation of a tangible asset may be divided 202 into a plurality of three-dimensional portions. In some implementations, distributed ownership management process 10 may determine how to divide the visual representation of the tangible asset based upon, at least in part, the measurable dimensions and the resolution of the visual representation of tangible asset in relation to predefined dimensions and a predefined resolution of each individual unit or portion making up the visual representation of the tangible asset. In some implementations, the total number of portions may be user-defined (e.g., via a user interface) and/or may be determined by distributed ownership management process 10. As will be discussed in greater detail below, distributed ownership management process 10 may retain or store the location, position, and/or coordinates of each portion of the plurality of portions of the visual representation of the tangible asset within a storage device (e.g., a database).

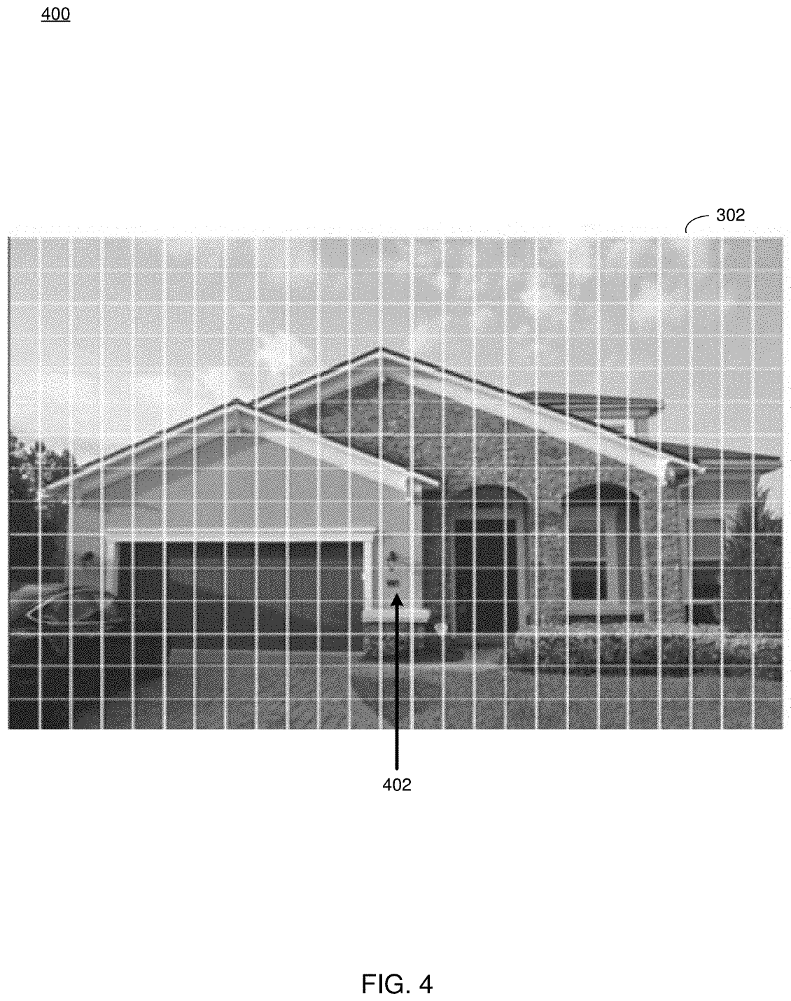

In some implementations, dividing 202 the visual representation of the tangible asset into the plurality of portions may include dividing 210 the visual representation of the tangible asset into a plurality of equal-sized portions. Referring again to the example of FIG. 4 and in some implementations, distributed ownership management process 10 may divide 202 visual representation 302 into a plurality of equal-sized portions (e.g., portion 402). In this example, distributed ownership management process 10 may divide 210 visual representation 302 into a plurality of equal-sized squares by defining a unit size (e.g., in number of pixels and/or an area size of each unit). Referring again to the example of FIG. 4 and in some implementations, distributed ownership management process 10 may divide 210 visual representation 302 into e.g., 375 equal-sized (e.g., comparably dimensioned) square portions or square milli-units, where one specific portion or milli-unit is shown as portion 402. While FIG. 4 shows the visual representation 302 divided 210 into a plurality of equal-sized squares, it will be appreciated that the visual representation of a tangible asset may be divided 210 in any way. For example, distributed ownership management process 10 may divide 210 a visual representation of a tangible asset into a plurality of e.g., triangular shapes, circular shapes, portions with equal area, three-dimensional shapes (e.g., for three-dimensional visual representations), etc.

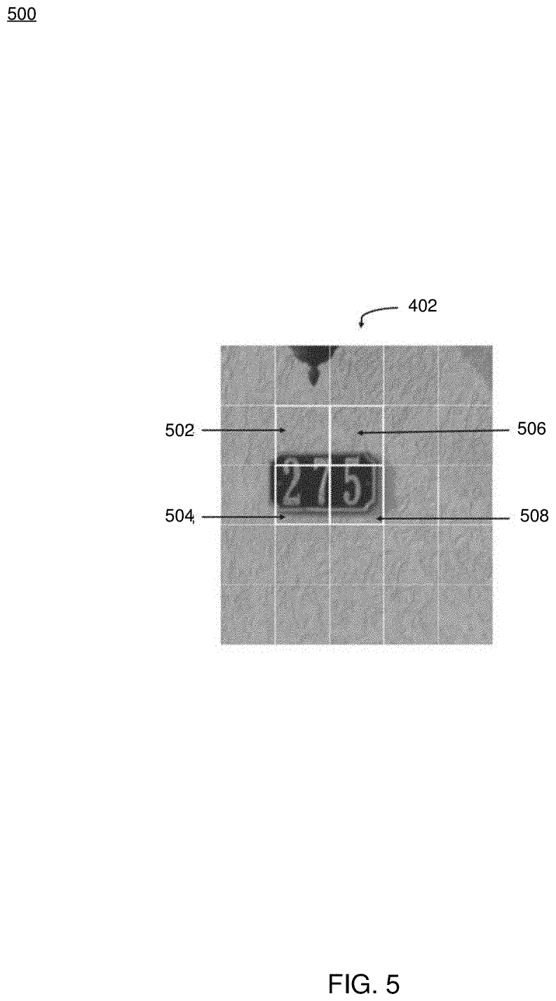

In some implementations, the plurality of equal-sized portions may include a plurality of equal-sized units and a plurality of equal-sized sub-units associated with each equal-sized unit. Referring also to the example of FIG. 5 and in some implementations, each portion of the plurality of portions may be an equal-sized unit (e.g., portion 402). In some implementations, distributed ownership management process 10 may further divide 202 the plurality of portions (e.g., portion 402 or unit 402) into a plurality of sub-units (e.g., plurality of sub-units 502, 504, 506, 508). In some implementations, each sub-unit (e.g., sub-units 502, 504, 506, 508) may be divided into further sub-units. In some implementations, the granularity of the portions or units may be user-defined and/or determined by distributed ownership management process 10 (e.g., a default granularity, based upon an average number of units across various visual representations, etc.).

In some implementations, dividing 202 the visual representation of the tangible asset into the plurality of portions may be based upon, at least in part, a value of the tangible asset. Referring again to the example of FIG. 3, suppose the tangible asset (e.g., the single-family house) has an estimated value of e.g., $375,000. In this example, distributed ownership management process 10 may divide 202 the visual representation 302 into a plurality of portions based upon, at least in part, the estimated value of the tangible asset (e.g., $375,000). In some implementations, distributed ownership management process 10 may divide 202 the visual representation of the tangible asset such that each portion has a predefined, unit value. For example and referring again to FIG. 4, distributed ownership management process 10 may divide 202 visual representation 302 into e.g., portions with an equal value (e.g., $1,000). In some implementations, such equal-valued portions may also be equal-sized. In this example, distributed ownership management process 10 may divide 202 visual representation 302 into e.g., 375 portions or units (e.g., portion 402) such that each portion represents e.g., a $1,000 value of the total estimated value of the tangible asset. In this example, each portion (e.g., portion 402) may be referred to as a milli-unit. While an example of equal-valued portions representing a value of $1,000 has been described above, it will be appreciated that any value may be used within the scope of the present disclosure. For example, it will be appreciated that distributed ownership management process 10 may divide the visual representation into any number of portions or units. In this manner, the use of “milli” in milli-units does not require the size of the unit to be 1/1,000^{th} of the size of the visual representation of the tangible asset or the value to be 1/1,000^{th} of the value of the tangible asset. For example, suppose a tangible asset was valued at e.g., $999. In this example, distributed ownership management process 10 may divide 202 the visual representation of the tangible asset valued at $999 into equal-sized portions such that each portion has an equal value and the total number of portions is a whole number. As such and in this example, distributed ownership management process 10 may divide 202 the visual representation of the tangible asset valued at $999 into e.g., 111 portions such that each portion is equally valued at e.g., $9.

As discussed above and in some implementations, distributed ownership management process 10 may further divide each portion or unit into various sub-units. Returning to the example of FIG. 5, suppose that each portion (e.g., portion 402) or milli-unit is further divided into e.g., 25 sub-units (e.g., plurality of sub-units 502, 504, 506, 508) such that the value of each sub-unit is e.g., $40. In some implementations, sub-units of a milli-unit may be referred to as micro-units. It will be appreciated that distributed ownership management process 10 may divide milli-units into any number of sub-units. In this manner, the use of “micro” in micro-units does not require the size of the sub-unit to be 1/1,000,000^{th} of the size of the visual representation of the tangible asset or the value to be 1/1,000,000^{th} of the value of the tangible asset. In this example, the visual representation 302 may include 375 milli-units each comprising 25 micro units each or 9,375 micro-units in total, with each micro-unit valued at approximately $40 apiece.

In some implementations and depending upon the value of the tangible asset and the resolution of the visual representation of the tangible asset, distributed ownership management process 10 may further divide each sub-unit into further sub-units. For example, returning to the above example where each portion or unit may be referred to as a milli-unit, where each sub-portion may be referred to as a micro-unit, distributed ownership management process 10 may further divide each micro-unit into smaller sub-units, which may be called nano-units. Subsequently, nano-units may be even further divided into even smaller sub-units, which may then be called pico-units, and so on and so forth to maintain the same submetric prefix naming convention used by the International Bureau of Weight and Measures International System of Units. As such, it will be appreciated that each level of division of a portion or unit may be represented by a separate submetric prefix. In some implementations and as discussed above, it will be appreciated that the submetric prefix naming convention is for example purposes only and may not indicate the value or size of each sub-unit relative to the original portion size. For example, the term “milli” may not represent 1/1,000^{th} of a unit but may represent a first level of subdivision of a portion or unit and the term “micro” may not represent 1/1,000,000^{th} of a unit but may represent a second level of subdivision of a portion or unit.

In some implementations and depending on the asset type, the dimensions of units may alter from one tangible asset to another. Additionally, dimensions of units may differ from one subdivision level to another subdivision level. In some implementations and as will be discussed in greater detail below, distributed ownership management process 10 may restrict the number of units available for ownership, while increasing the per unit value. In some implementations, distributed ownership management process 10 may ensure that future units can be unlocked at a later date to reflect the growth in value of a tangible asset (e.g., the increase in value to a single-family house by adding solar panels).

In some implementations and upon dividing the visual representation of the tangible asset into a plurality of portions or units, distributed ownership management process 10 may process data regarding the plurality of portions of the tangible asset (e.g., all milli-units, micro-units, nano-units, etc.) to be stored in a mechanism to be electronically accessed, queried, modified, or generally available to be cryptographically audited. In some implementations, data, regarding each portion of the plurality of portions of the visual representation may be stored separately from data for the tangible asset, but may be referenceable as being part of the visual representation of the tangible asset.

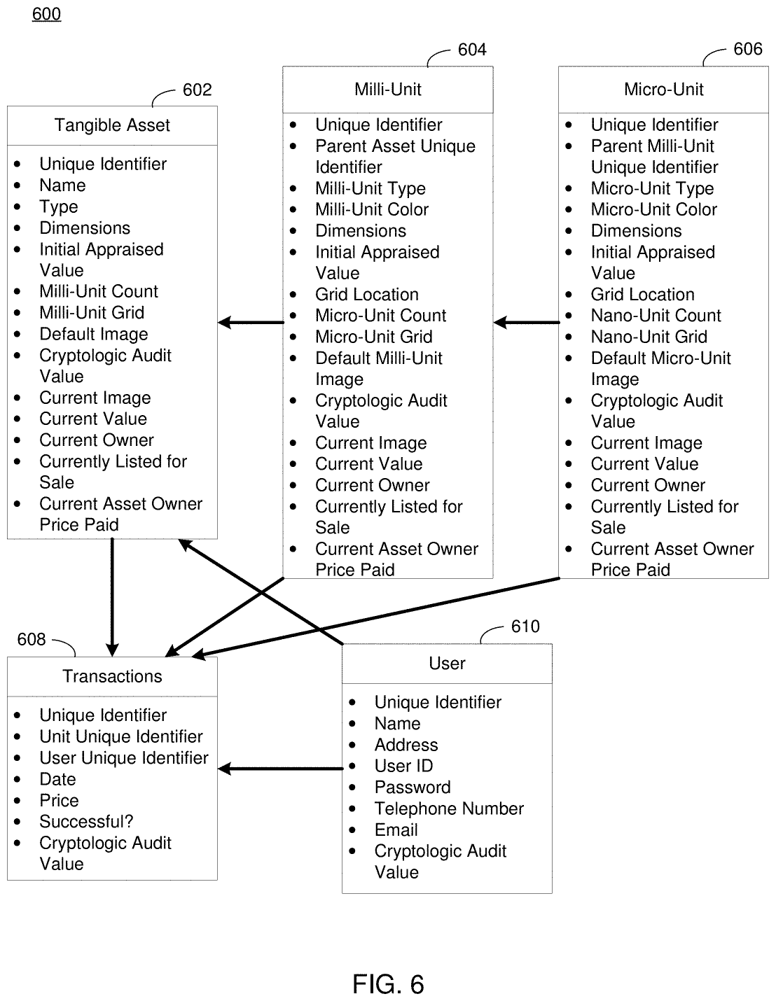

Referring also to the example of FIG. 6 and in some implementations, distributed ownership management process 10 may store information or data associated with tangible assets, portions of visual representations of tangible assets, transactions, users, etc. in various tables within a storage mechanism or database. For example and in response to receiving 200 a visual representation of a tangible asset and information associated with the tangible asset, distributed ownership management process 10 may generate a table entry (e.g., tangible asset entry 602) for a particular tangible asset. In some implementations and in response to dividing 202 a visual representation of the tangible asset into a plurality of portions, distributed ownership management process 10 may generate a table entry for each portion and/or each sub-portion of the visual representation of the tangible asset (e.g., milli-unit entry 604 and micro-unit entry 606). In some implementations and as will be discussed in greater detail below, in response to a user being associated 208 with a particular portion of a visual representation of a tangible asset, distributed ownership management process 10 may generate a transaction entry (e.g., transaction entry 608). In some implementations and in response to user selection(s) of at least one portion of a visual representation of a tangible asset, distributed ownership management process 10 may generate or modify an entry for a user (e.g., user entry 610). While FIG. 6 may provide an exemplary arrangement of entries or tables in a database, it will be appreciated that any database or storage scheme may be used to store information or data associated with tangible assets, portions of visual representations of tangible assets, transactions, users, etc. within the scope of the present disclosure.

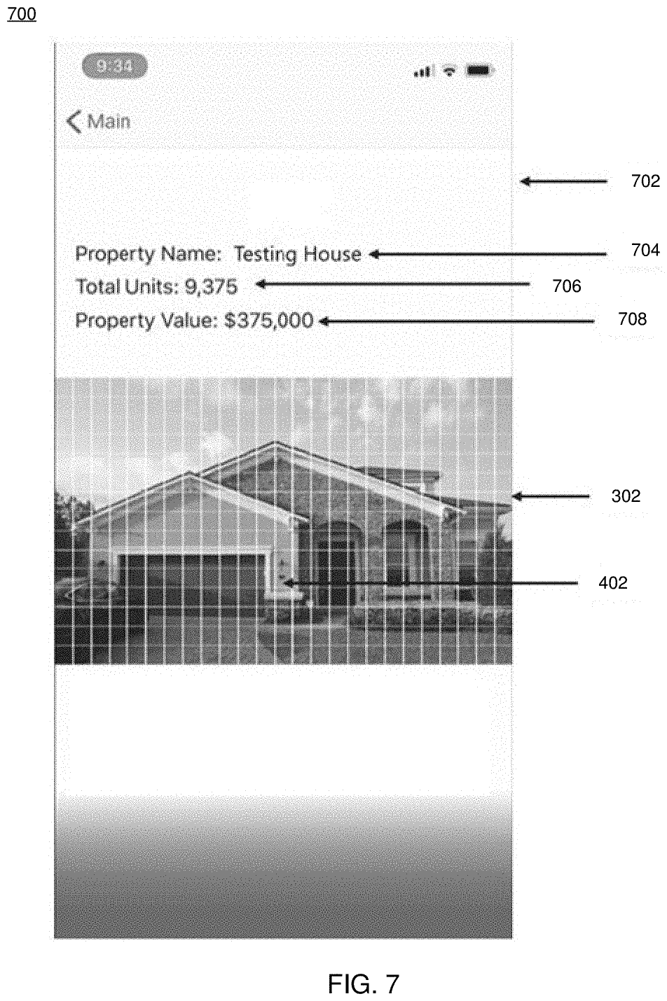

In some implementations, distributed ownership management process 10 may provide 204, to at least one computing device, the plurality of portions of the visual representation of the tangible asset for display within a graphical user interface of the at least one computing device. Referring also to the example of FIG. 7 and in some implementations, distributed ownership management process 10 may provide 204, to at least one computing device (e.g., client electronic devices 38, 40, 42, 44), the plurality of portions (e.g., represented by portion 402) of the visual representation of the tangible asset (e.g., visual representation 302) for display within a graphical user interface (e.g., graphical user interface 702) of the at least one computing device. In some implementations, distributed ownership management process 10 may cause graphical user interface 702 to display in response to the computing device accessing a particular website, by downloading an application, etc. In some implementations, providing 204 the plurality of portions of the visual representation of the tangible asset may include providing information (e.g., from a storage mechanism, such as tables of a database as shown in FIG. 6) associated with the tangible asset.

For example, suppose a user (e.g., user 46) is seeking to obtain an ownership interest in a portion of a tangible asset. In this example, distributed ownership management process 10 may provide 204, to computing device 38 being used by user 46, the plurality of portions (e.g., represented by portion 402) of the visual representation of the tangible asset (e.g., visual representation 302 representative of a single-family house). In some implementations, distributed ownership management process 10 may provide information associated with the tangible asset for display in the graphical user interface of the computing device used by the user. In this example, distributed ownership management process 10 may provide information associated with the tangible asset (e.g., tangible asset property name 704, a total number of portions or units for the tangible asset 706, and a tangible asset property value 708) for display in graphical user interface 702. However, it will be appreciated that other information associated with the tangible asset may be provided for display within the scope of the present disclosure. In some implementations, a user may define which information associated with a tangible asset is displayed in their graphical user interface.

In some implementations, distributed ownership management process 10 may enable a user to zoom in or drill-down on the plurality of portions of the visual representation of the tangible asset in order to see the complete visual representation of the tangible asset, portions or units of the visual representation of the tangible asset, groupings of milli-units, grouping of micro-units, groupings of nano-units, etc. In some implementations, distributed ownership management process 10 may provide a zoom out or back button on graphical user interface 702 to allow a user to reverse the zoom in or drill-down process.

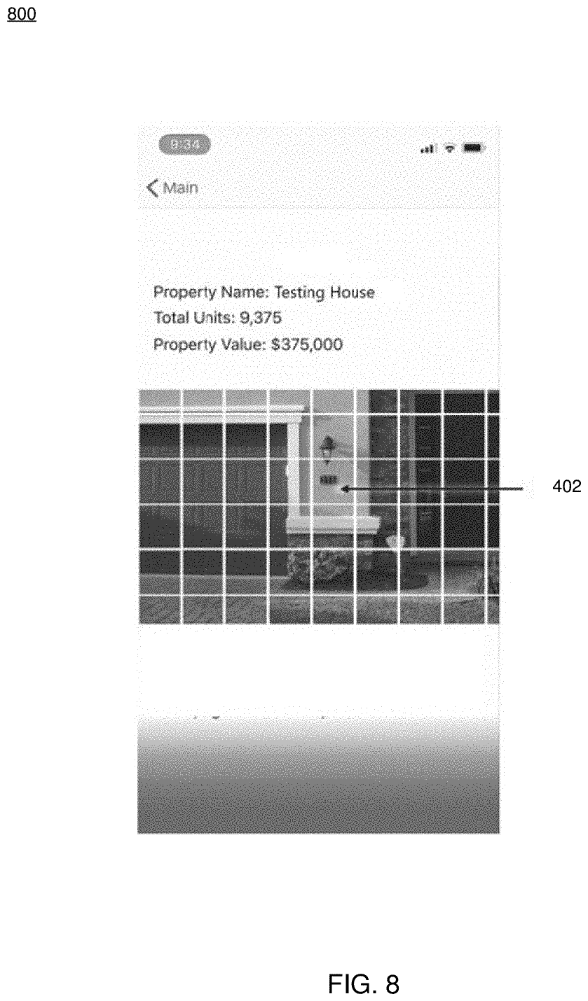

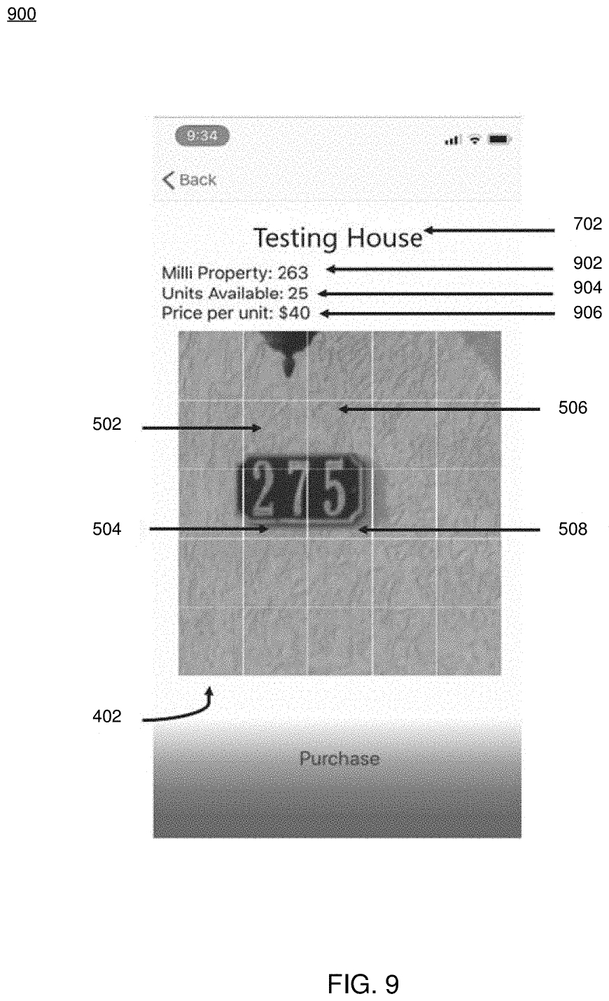

For example, suppose a user is shown the visual representation of the tangible asset as depicted in FIG. 7. Further suppose the user interacts with graphical user interface 702 (e.g., via a pinch zoom method, a screen selection of a zoom button, etc.) to transition to FIG. 8, which goes from showing the entire digitized tangible asset (as shown in FIG. 7) to a specific section with milli-unit 402 being approximately in the center (as shown in FIG. 8). In some implementations, a user may zoom in/drill down further into the plurality of portions to view a plurality of sub portions. For example, suppose the user further interacts with graphical user interface 702 (e.g., via a pinch zoom method, a screen selection of a zoom button, etc.) to transition to FIG. 9, which goes from showing a zoomed-in version of the plurality of portions of the visual representation of the tangible asset to a view of the micro-units (e.g., sub-units/micro-units 502, 504, 506, 508) of milli-unit 402. In this manner, distributed ownership management process 10 may allow a user to view various levels of the division of the visual representation of the tangible asset via a graphical user interface. In some implementations, distributed ownership management process 10 may allow a user to rotate the visual representation of the tangible asset. For example, suppose the visual representation of a tangible asset is a three-dimensional rendering of the tangible asset. In this example, distributed ownership management process 10 may allow a user to rotate the visual representation of the tangible asset. While examples of a zoom feature and a rotate feature have been provided, it will be appreciated that any interaction feature may be used within the scope of the present disclosure.

In some implementations, distributed ownership management process 10 may receive 206, from the at least one computing device, a user selection of at least one portion of the plurality of portions of the visual representation of the tangible asset. Returning to the previous example, suppose a user selects portion 402 of FIG. 8. Distributed ownership management process 10 may provide a plurality of sub-units or micro-units associated with portion 402 for display in graphical user interface 702 (as shown in FIG. 9). In some implementations, distributed ownership management process 10 may provide information associated with the selected portion (e.g., portion 402). Examples of information provided by distributed ownership management process 10 may generally include a unique identifier for the selected unit or portion (e.g., unique identifier 902), a number of micro-units available, i.e., not already associated with a user (e.g., number of units available 904), a price per micro-unit (e.g., price per unit 906), etc. In some implementations, each individual portion of the visual representation of the tangible asset (e.g., each milli-unit, micro-unit, nano-unit, etc.) may be selected and viewed independently from the whole, using various input capabilities of a user's computing device.

In some implementations, distributed ownership management process 10 may associate 208 the at least one selected portion of the visual representation of the tangible asset with the user. In some implementations, associating 208 at least one selected portion of the visual representation of the tangible asset may generally include defining an ownership interest of the tangible asset based upon the selected portions of the visual representation of the tangible asset. For example, suppose a user would like to purchase e.g., four micro-units or sub-units of a tangible asset. Referring again to the example of FIG. 9, distributed ownership management process 10 may receive 206 a user selection (e.g., via an input method on the user's computing device) of e.g., four micro-units (e.g., sub-units 502, 504, 506, 508) of a portion (e.g., portion 402) of the visual representation of the tangible asset (e.g., visual representation 302).

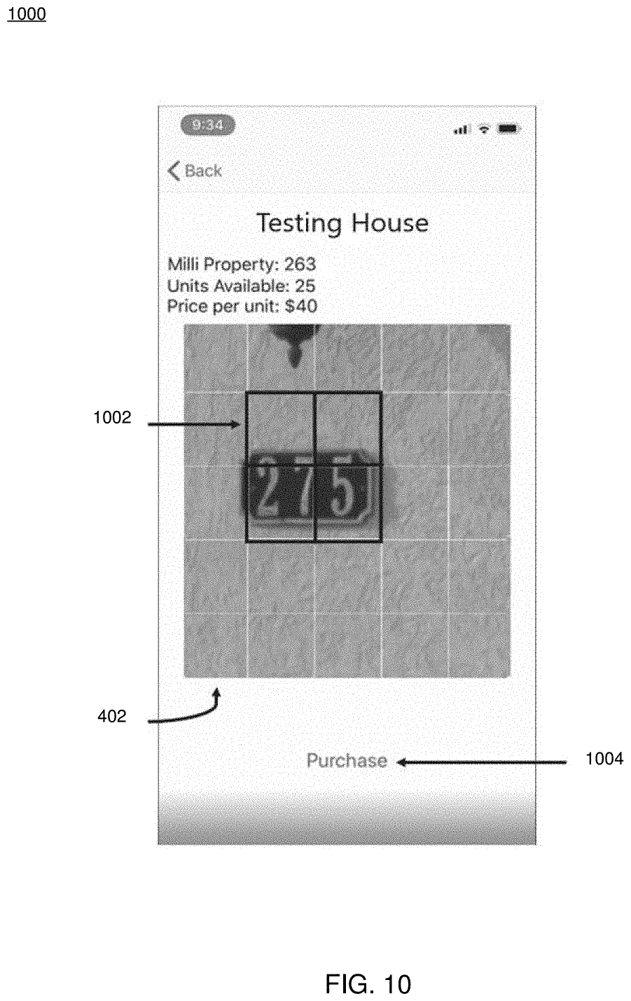

In some implementations and referring also to the example of FIG. 10, this selection of micro-units may be shown with an indicator unique to selection of portions or units (e.g., a bold line rendered around each selected portion). In this example, distributed ownership management process 10 may provide a purchase option (e.g., button 1004) to initiate a purchase transaction to associate 208 the selected portions of the visual representation of the tangible asset with the user. In this example, distributed ownership management process 10 may associate 208 e.g., four micro-units (e.g., micro-units 502, 504, 506, 508) with a user. In some implementations, associating 208 these e.g., four micro-units with a user may be in response to a user completing the purchase transaction. For example, distributed ownership management process 10 may confirm that a user has provided the required fee for purchasing the selected portions before associating 208 the selected portions with the user. In some implementations, once a purchasable unit, or multiple units, are selected by a user, distributed ownership management process 10 may associate 208 the selected unit with the user and the user may acquire the ownership right over the selected unit(s).

In some implementations, each individual portion or unit of the visual representation may represent an ownership interest of a tangible asset. Returning to the above example where a user purchases four micro-units, the four micro-units of the visual representation of the tangible asset associated with a user may define the user's 4/9375 ownership interest in the tangible asset (e.g., 4 micro-units owned of 9,375 total micro-units). In some implementations, each individual portion or unit and/or sub-unit may be owned independently from all the other portions or units of similar dimensions; however, only one user may be associated with/own a specific portion or unit at a time. In some implementations, if a parent unit (e.g., portion 402) is associated with a user, all child and sub-divisional units (if any) within that parent unit may also be associated with that user. In some implementations, each portion of the visual representation of the tangible asset may be a digital piece of the tangible asset. In this manner, a user may obtain ownership interest in a tangible asset separately from, but still in combination with, others by selecting and becoming associated with various portions of the visual representation of a tangible asset.

In some implementations, distributed ownership management process 10 may allow users to become associated 208 with the selected units of the visual representation of the tangible asset by providing the selected units at a defined initial price and/or by providing the selected units with an initial or minimum price. For example, distributed ownership management process 10 may allow users to submit purchase quotes or bids to acquire the selected portion or unit of the visual representation of the tangible asset. In some implementations, distributed ownership management process 10 may receive bids from users for a portion of the visual representation of the tangible asset. Distributed ownership management process 10 may determine which user submits the earliest and/or highest bid, while meeting any initial sale conditions, complete the transaction, and transfer ownership rights of the unit to the buyer (i.e., associate 208 the selected units with the buyer). In this manner, distributed ownership management process 10 may allow users to become associated with particular portions or units of a visual representation of a tangible asset via an auction system.

In some implementations, when one or more portions of the visual representation of the tangible asset are associated 208 with a user, distributed ownership management process 10 may update the information associated with the portions or units so all users of distributed ownership management process 10 can view those units as being associated with or owned by a particular user.

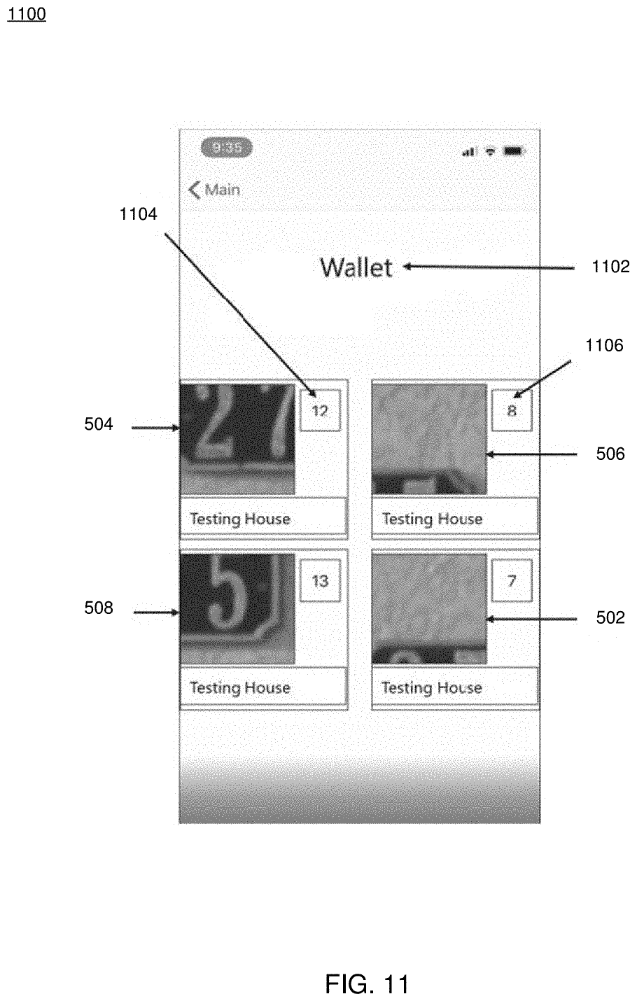

In some implementations and referring also to the example of FIG. 11, distributed ownership management process 10 may allow a user to view portions of visual representations of tangible assets that are associated with the user. For example, distributed ownership management process 10 may provide a wallet function (e.g., wallet 1102), which may synchronize data for a user's owned units between distributed ownership management process 10 and the user's computing device. Once a unit is owned/associated with the user, additional details may be displayed in the wallet section. In some implementations, distributed ownership management process 10 may generate unique identifiers for each portion or unit and/or sub-unit of the visual representation of the tangible asset. For example and as shown in FIG. 11, sub-unit 504 may have one or more unique identifiers (e.g., unique identifier 1104). In this example, “12” may indicate the unique identifier for sub-unit 504 within portion 402 (i.e., the 12^{th} sub-unit of 25 sub-units in portion 402). Similarly, sub-portion 506 may include a unique identifier (e.g., unique identifier 1106) of e.g., “8”; sub-portion 508 may include a unique identifier of e.g., “13”; and sub-portion 502 may include a unique identifier of e.g., “7”. In some implementations, distributed ownership management process 10 may cause other information to be displayed in wallet 1102 (e.g., the price paid for each portion unit, the tangible asset associated with each portion, the perceived present-day valuation of the portion, the percentage value comparing the price paid vs. the perceived present-day valuation, the date of purchase, etc.).

In some implementations, associating 208 the at least one selected portion of the visual representation of the tangible asset with the user may include enabling 212 a user to modify a visual appearance of the at least one selected portion of the visual representation of the tangible asset. In some implementations, a visual appearance of a portion of the visual representation of a tangible asset may be modified by its owner. For example, distributed ownership management process 10 may enable 212 the owner to modify the default image associated with an owned unit to be anything the owner can create using a digital graphic editor, a digital input device, or a digital upload functionality within the user interface. In some implementations, when modifications are made to the visual appearance of a portion of the visual representation of the tangible asset and saved, distributed ownership management process 10 may replace the default image with the submitted modified content. In some implementations, the owner of the portion may be able to return to the digital graphic editor and restore the original default image.

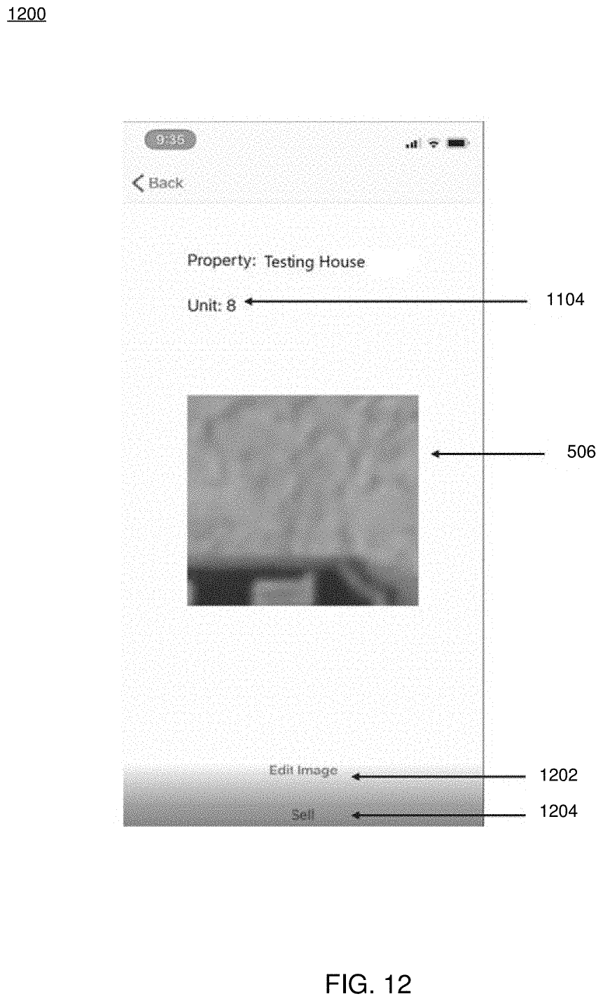

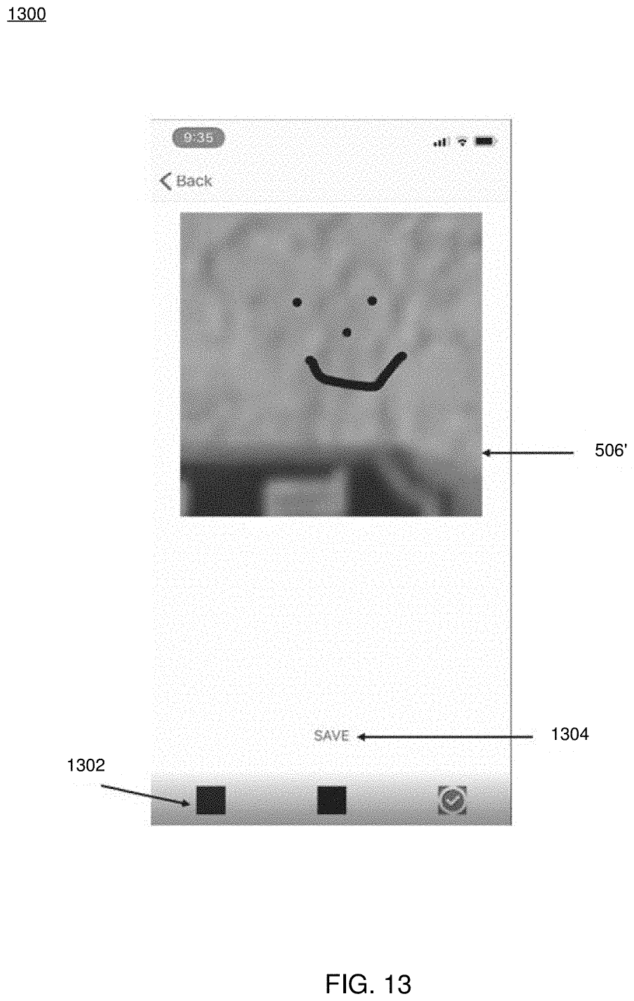

Referring also to the example of FIG. 12 and in some implementations, distributed ownership management process 10 may enable 212 a user to modify a visual appearance of the at least one selected portion of the visual representation of the tangible asset (e.g., sub-portion 506) by providing a selectable option (e.g., “Edit Image” button 1202). In this example and in response to receiving a user selection of “Edit Image” button 1202, distributed ownership management process 10 may transition the user to a digital graphic editor as shown in the example of FIG. 13. Referring also to FIG. 13 and in some implementations, a user may use input capabilities of their computing device to e.g., select a color from a drawing feature (e.g., digital graphic editor tool bar 1302). In this example, suppose a user modifies the visual appearance of sub-unit 506 by e.g., drawing what appears to be a smiley face on top of the original image of sub-unit 506. When the user selects a save button (e.g., save button 1304), distributed ownership management process 10 may replace the existing visual appearance of sub-unit 506 with the modified visual appearance (e.g., sub-portion 506′). In some implementations, the modified visual appearance may impact all users, who would then see sub-unit 506′ instead, unless and until the owner reverts sub-unit 506′ back to the original appearance (e.g., as shown in FIG. 12). While one example of how a user may modify the visual appearance of a portion of the visual representation of a tangible asset has been provided, it will be appreciated that distributed ownership management process 10 may enable 212 a user to modify the visual appearance of a portion of the visual representation of the tangible asset in any way within the scope of the present disclosure.

In some implementations, distributed ownership management process 10 may provide 214 a visual indicator for the plurality of portions of the visual representation of the tangible asset indicative of whether each portion of the visual representation of the tangible asset is associated with any user. For example, a portion or unit may have three different ownership situations depending upon, at least in part, the availability of sub-units associated with the portion or unit: 1) all sub-units are available for purchase; 2) one or more sub-units are available for purchase; or 3) no sub-units are available for purchase. In some implementations, distributed ownership management process 10 may provide 214 a unique visual indicator for each ownership situation. In some implementations, distributed ownership management process 10 may provide 214 a distinct visual indicator to differentiate the status of a portion or unit compared to other comparably dimensioned portions or units. In some implementations, if a portion or unit does not have any sub-units, its ownership situation may be either owned or unowned.

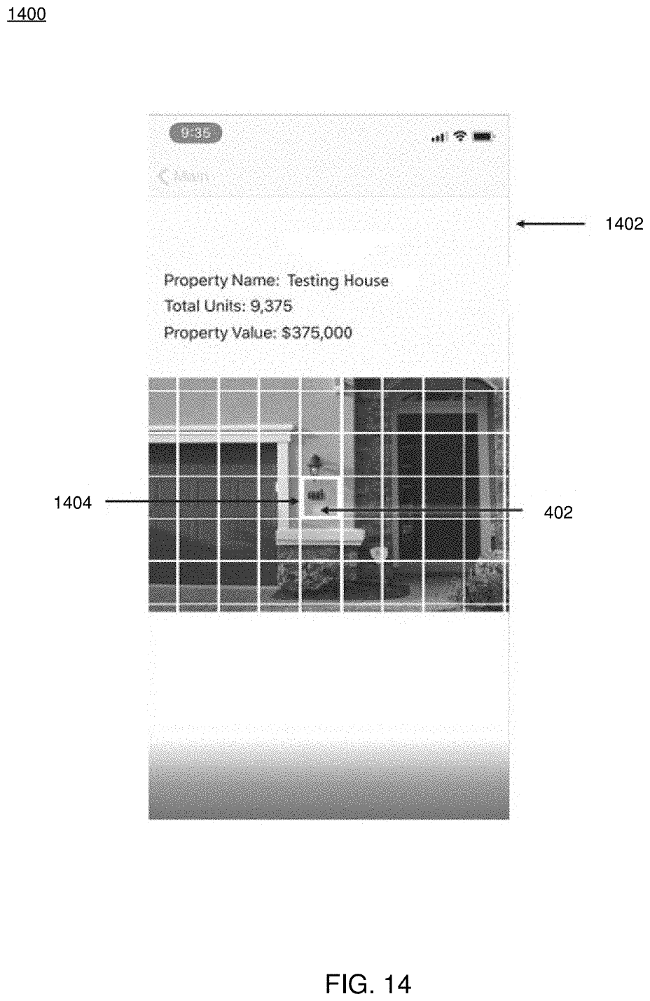

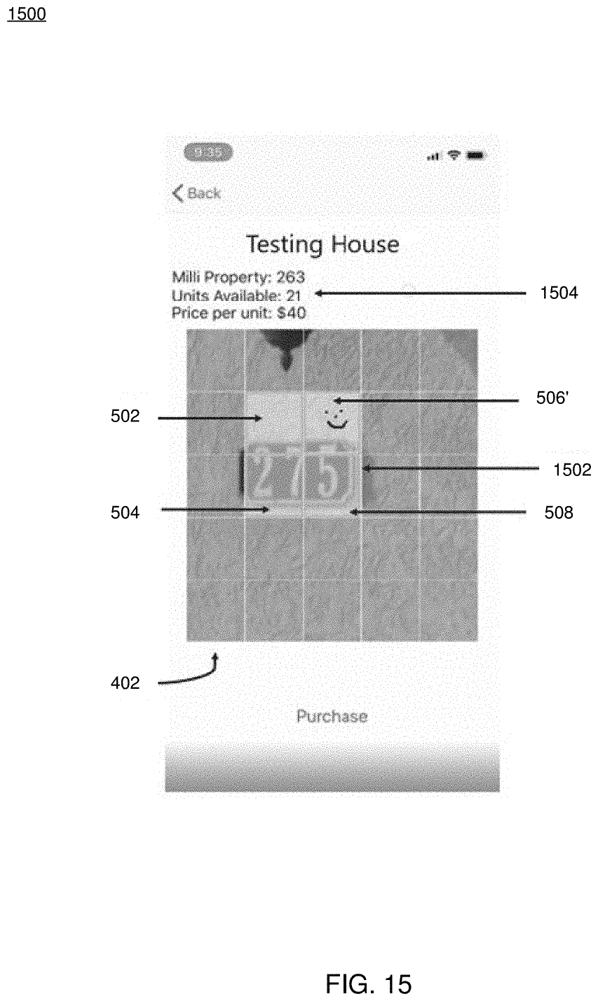

Referring also to the example of FIG. 14 and in some implementations, a milli-unit (e.g., portion or milli-unit 402) may have some of its micro-units or sub-units owned/associated with a user. In this example, distributed ownership management process 10 may provide 214 a visual indicator to differentiate milli-unit 402 from the other milli-units. For example, distributed ownership management process 10 may generate a unique border (e.g., border 1404) around milli-unit 402 to indicate that one or more sub-units of milli-unit 402 are owned. Referring also to the example of FIG. 15 and in some implementations, as milli-unit 402's micro-units 502, 504, 506, and 508 are owned, distributed ownership management process 10 may provide 214 a unique visual indicator to distinguish these owned micro-units from unowned micro-units within milli-unit 402. In one example, distributed ownership management process 10 may provide a different colored border or shading (e.g., shading 1502) around or overlaid on the owned micro-units (e.g., micro-units 502, 504, 506, 508). In some implementations, these visual indicators may assist other users to determine which units or portions of a visual representation of a tangible asset are available (e.g., to purchase). In some implementations and as shown in the example of FIG. 15, as e.g., four out of the 25 micro-units are owned within milli-unit 402, the units available (e.g., units available indicator 1504) may change from “25 to “21”.

In some implementations, associating 208 the at least one selected portion of the visual representation of the tangible asset with the user may include enabling 216 the user to convey the at least one selected portion of the visual representation of the tangible asset to another user. For example, once a user is associated with a portion of the visual representation of the tangible asset, the user may own a portion of the tangible asset. In some implementations, distributed ownership management process 10 may allow a user to obtain the transactional ability to transfer or convey the portion or unit to another user and/or to list the portion or unit for sale. In some implementations, distributed ownership management process 10 may enable 216 the owner of a portion or unit to select another user to convey the portion or unit to. In some implementations, distributed ownership management process 10 may enable 216 an owner to convey a portion or unit via a transaction. For example and as will be discussed in greater detail below, a user may, via distributed ownership management process 10, define sale conditions, such as, but not limited to, how long to list the sale, a minimum asking purchase price, etc. for a portion of the visual representation of the tangible asset currently associated with the user.

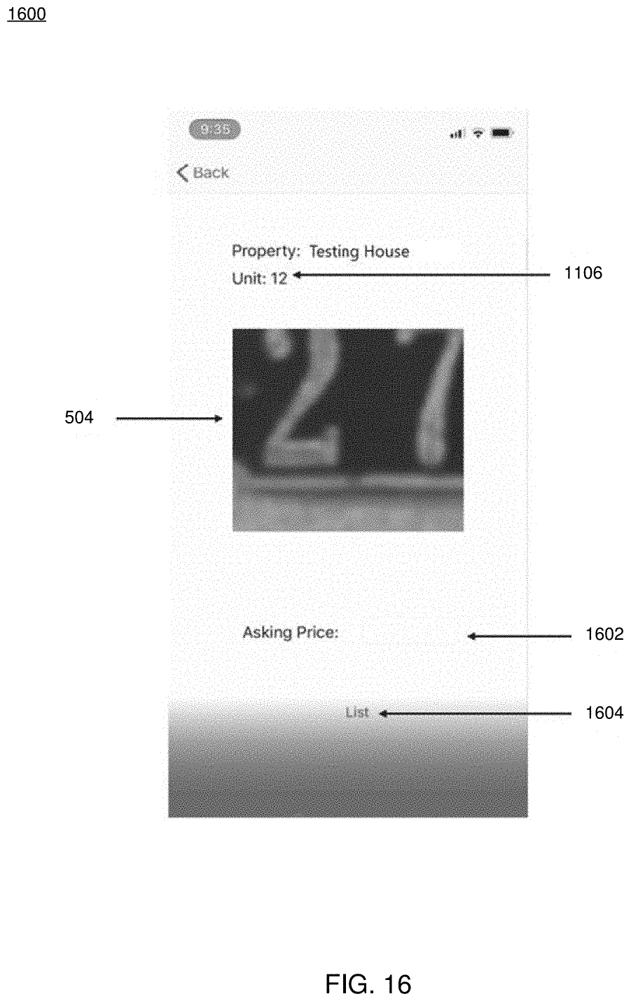

In some implementations, associating 208 the at least one selected portion of the visual representation of the tangible asset with the user may include enabling 218 the user to define a price for the at least one selected portion of the visual representation of the tangible asset. Referring also to the example of FIG. 16 and in some implementations, a user may select a portion of the visual representation of the tangible asset that the user is associated with (e.g., micro-unit 504) and may define a price for the selected portion (e.g., by inputting a price into text field 1602). In some implementations, a user may list the selected portion for sale by selecting a list button (e.g., list button 1604). In some implementations, when a user finalizes a transfer or list-for-sale transaction, distributed ownership management process 10 may update an impacted portion's data to reflect the new status. Once updated, distributed ownership management process 10 may allow all users to see any status modifications for a particular portion or unit.

In some implementations, following a user listing a portion of the visual representation of the tangible asset, distributed ownership management process 10 may allow other users to purchase portions of the visual representation of the tangible unit in a similar manner as described above (e.g., receiving 206 a selection of at least one portion of the visual representation of the tangible asset and associating 208 the selected at least one portion of the visual representation of the tangible asset with the user). In some implementations, as an owned unit is listed for sale, other users may, via distributed ownership management process 10, submit purchase quotes or bids to acquire the portion or unit. In some implementations, distributed ownership management process 10 may receive bids from users for a portion of the visual representation of the tangible asset associated with another user. Distributed ownership management process 10 may determine which user submits the earliest and/or highest bid, while meeting all the sale conditions set by the owner, complete the transaction, and transfer ownership rights of the unit from the seller to the buyer. In some implementations, distributed ownership management process 10 may enable a user to submit a bid for a portion or unit associated with/owned by another user, even when the portion or unit is not listed for sale by the owner.

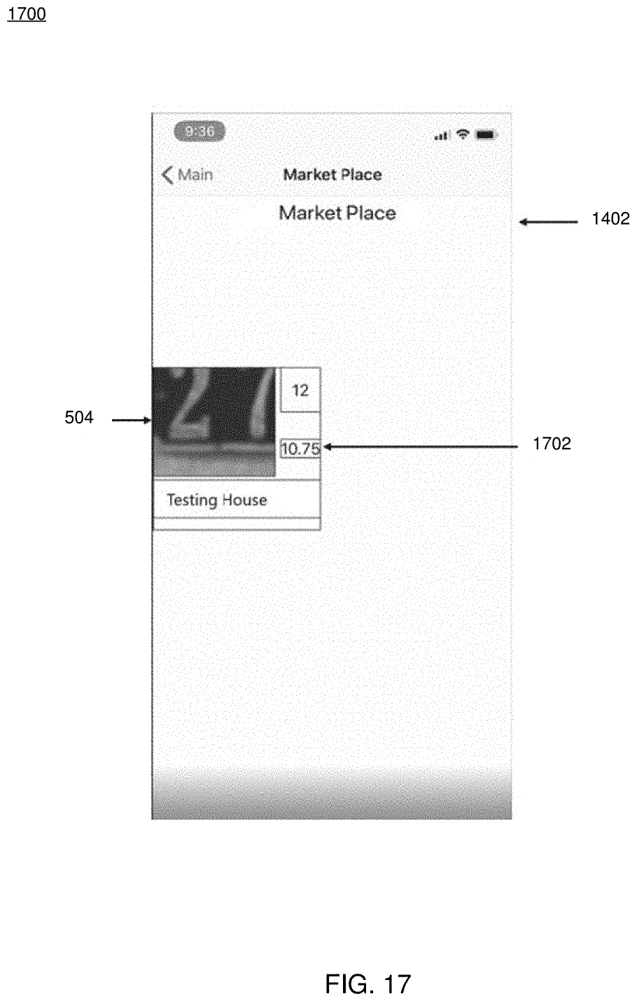

Referring also to the example of FIG. 17 and in some implementations, a portion of the visual representation of the tangible asset (e.g., micro-unit 504) may be listed in a “market place” feature of the application, being seen through a second user's interface (e.g., user interface 1402), who is not associated with the displayed portion (e.g., micro-unit 504). In some implementations, distributed ownership management process 10 may provide the portion of the visual representation of the tangible asset with various information, such as the owner's minimum asking purchase price (e.g., minimum asking price 1702).

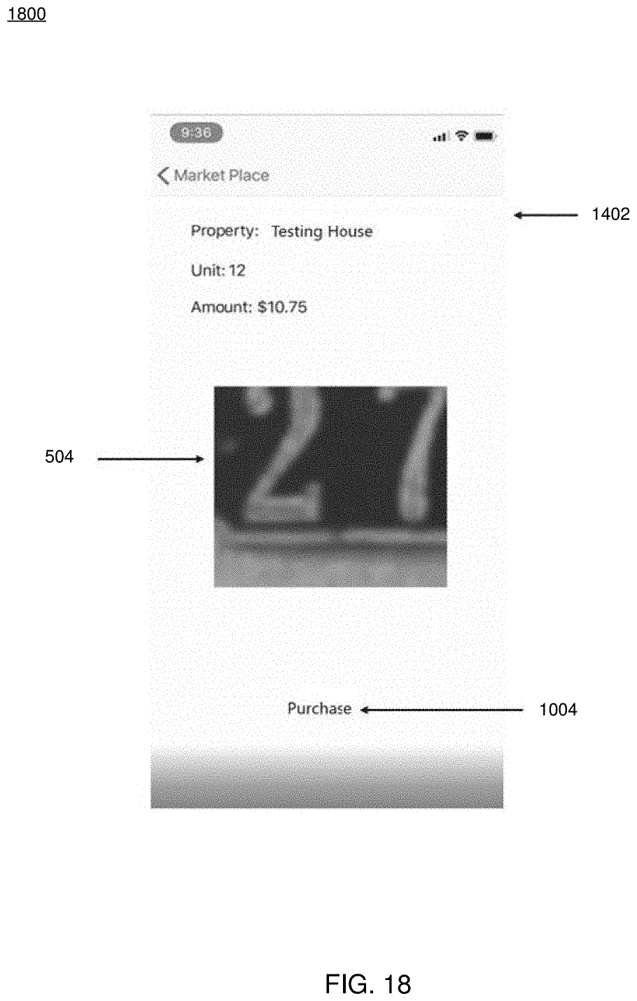

Referring also to the example of FIG. 18 and in some implementations, to purchase a portion of the visual representation of the tangible asset (e.g., micro-unit 504), a second user may select the portion of the visual representation of the tangible asset (e.g., micro-unit 504). Distributed ownership management process 10 may transition to the user interface shown in FIG. 18 which may cause, upon receiving a selection of a “Purchase” button (e.g., purchase button 1004), distributed ownership management process 10 to initiate a financial transaction to associate 208 the unit with the second user and disassociating the unit with the previous owner.

In some implementations, distributed ownership management process 10 may allow each portion of the visual representation of the tangible asset to have its own independent value. In this manner, distributed ownership management process 10 may allow for the value of the portion of the visual representation of the tangible asset to fluctuate independently from the value of the tangible asset or other comparably dimensioned portions. For example, other users may perceive different value of each portion based on various criteria, such as, but not limited to, any visual appearance modifications made by the owner, traditional supply and demand, perceived potential future value, the unique position of the portion of the visual representation of the tangible asset in relation to the overall visual representation of the tangible asset, etc.

In some implementations, distributed ownership management process 10 may monitor 220 one or more user interactions with the plurality of portions of the visual representation of the tangible asset. Referring again to the example of FIG. 18 and in some implementations, suppose a user interacts with (e.g., selects) micro-unit 504 from milli-unit 402. In this example, distributed ownership management process 10 may provide information associated with micro-unit 504 for the user to view (e.g., name of tangible asset, a unique identifier for the portion and/or sub-unit, a price or value, a user-modified visual appearance of the portion or sub-unit, etc.). In some implementations, distributed ownership management process 10 may monitor 220 and store information associated with the user's interactions with various portions and/or sub-units of the visual appearance of the tangible asset. As will be discussed in greater detail below and in some implementations, distributed ownership management process 10 may preload 222 information associated with a particular portion based upon, at least in part, the user's interactions monitored 220 by distributed ownership management process 10.

In some implementations and in response to monitoring 220 at least a threshold number of user interactions with a particular portion of the virtual representation of the tangible asset, distributed ownership management process 10 may preload 222 information associated with the particular portion of the virtual representation of the tangible asset to a computing device associated with the user during a subsequent user interaction with the plurality of portions of the virtual representation of the tangible asset. In some implementations, the threshold number of user interactions may be user-definable and/or defined by distributed ownership management process 10. Continuing with the above example, suppose a user interacts with micro-unit 504 a threshold number of times as defined by distributed ownership management process 10 (e.g., at least three times). In some implementations, as opposed to reloading information associated with micro-unit 504 to the user's computing device each time, distributed ownership management process 10 may preload 222 information associated with micro-unit 504 to the user's computing device when the user begins any interaction with the visual representation of the tangible asset in response to determining that the user has at least a threshold number of interactions with micro-unit 504. In this manner, the user's experience interacting with portions of the visual appearance of the tangible asset may be improved by preloading information associated with particular portions the user has interacted with at least a threshold number of times. While an example of e.g., three interactions has been provided as an example of a threshold number of interactions, it will be appreciated that any number of interactions may be used as the threshold within the scope of the present disclosure.

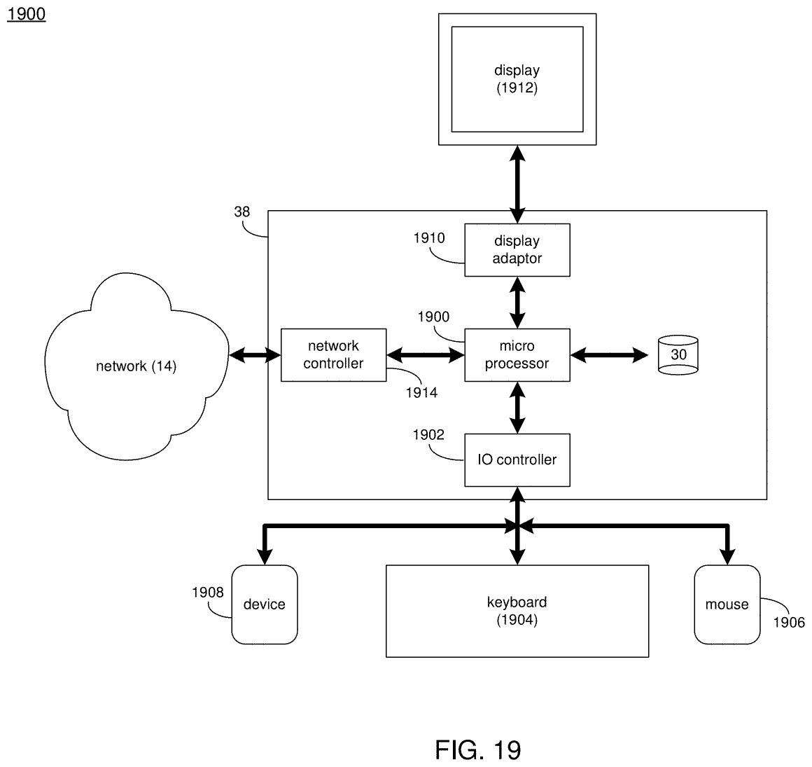

Referring also to the example implementation of FIG. 19, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, distributed ownership management process 10 may be substituted for client electronic device 38 (in whole or in part) within FIG. 19, examples of which may include but are not limited to computer 12 and/or one or more of client electronic devices 40, 42, 44.

In some implementations, client electronic device 38 may include a processor (e.g., microprocessor 1900) configured to, e.g., process data and execute the above-noted code/instruction sets and subroutines. Microprocessor 1900 may be coupled via a storage adaptor to the above-noted storage device(s) (e.g., storage device 30). An I/O controller (e.g., I/O controller 1902) may be configured to couple microprocessor 1900 with various devices (e.g., via wired or wireless connection), such as keyboard 1904, pointing/selecting device (e.g., touchpad, touchscreen, mouse 1906, etc.), USB ports, printer ports, and other devices 1908. A display adaptor (e.g., display adaptor 1910) may be configured to couple display 1912 (e.g., touchscreen monitor(s), plasma, CRT, or LCD monitor(s), etc.) with microprocessor 1900, while network controller/adaptor 1914 (e.g., an Ethernet adaptor) may be configured to couple microprocessor 1900 to the above-noted network 14 (e.g., the Internet or a local area network).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, executed on a computing device, comprising:
receiving, via the computing device, a visual representation of a tangible asset;
dividing the visual representation of the tangible asset into a plurality of portions;
providing, to at least one computing device, the plurality of portions of the visual representation of the tangible asset for display within a graphical user interface of the at least one computing device;
receiving, from the at least one computing device, a user selection of at least one portion of the plurality of portions of the visual representation of the tangible asset; and
associating the at least one selected portion of the visual representation of the tangible asset with the user.

2. The computer-implemented method of claim 1, wherein dividing the visual representation of the tangible asset into the plurality of portions includes dividing the visual representation of the tangible asset into a plurality of equal-sized portions.

3. The computer-implemented method of claim 2, wherein the plurality of equal-sized portions include a plurality of equal-sized units and a plurality of equal-sized sub-units associated with each equal-sized unit.

4. The computer-implemented method of claim 1, wherein dividing the visual representation of the tangible asset into the plurality of portions is based upon, at least in part, a value of the tangible asset.

5. The computer-implemented method of claim 1, wherein associating the at least one selected portion of the visual representation of the tangible asset with the user includes one or more of:
enabling the user to convey the at least one selected portion of the visual representation of the tangible asset to another user;
enabling the user to define a price for the at least one selected portion of the visual representation of the tangible asset; and
enabling a user to modify a visual appearance of the at least one selected portion of the visual representation of the tangible asset.

6. The computer-implemented method of claim 1, further comprising:
providing a visual indicator for the plurality of portions of the visual representation of the tangible asset indicative of whether each portion of the visual representation of the tangible asset is associated with any user.

7. The computer-implemented method of claim 1, further comprising:
monitoring one or more user interactions with the plurality of portions of the visual representation of the tangible asset; and
in response to monitoring at least a threshold number of user interactions with a particular portion of the virtual representation of the tangible asset, preloading information associated with the particular portion of the virtual representation of the tangible asset to a computing device associated with the user during a subsequent user interaction with the plurality of portions of the virtual representation of the tangible asset.

8. A computer program product residing on a non-transitory computer readable medium having a plurality of instructions stored thereon which, when executed by a processor, cause the processor to perform operations comprising:
receiving a visual representation of a tangible asset;
dividing the visual representation of the tangible asset into a plurality of portions;
providing the plurality of portions of the visual representation of the tangible asset for display within a graphical user interface of at least one computing device;
receiving, from the at least one computing device, a user selection of at least one portion of the plurality of portions of the visual representation of the tangible asset; and
associating the at least one selected portion of the visual representation of the tangible asset with the user.

9. The computer program product of claim 8, wherein dividing the visual representation of the tangible asset into the plurality of portions includes dividing the visual representation of the tangible asset into a plurality of equal-sized portions.

10. The computer program product of claim 9, wherein the plurality of equal-sized portions include a plurality of equal-sized units and a plurality of equal-sized sub-units associated with each equal-sized unit.

11. The computer program product of claim 8, wherein dividing the visual representation of the tangible asset into the plurality of portions is based upon, at least in part, a value of the tangible asset.

12. The computer program product of claim 8, wherein associating the at least one selected portion of the visual representation of the tangible asset with the user includes one or more of:
enabling the user to convey the at least one selected portion of the visual representation of the tangible asset to another user;
enabling the user to define a price for the at least one selected portion of the visual representation of the tangible asset; and
enabling a user to modify a visual appearance of the at least one selected portion of the visual representation of the tangible asset.

13. The computer program product of claim 8, further comprising:
providing a visual indicator for the plurality of portions of the visual representation of the tangible asset indicative of whether each portion of the visual representation of the tangible asset is associated with any user.

14. The computer program product of claim 8, further comprising:
monitoring one or more user interactions with the plurality of portions of the visual representation of the tangible asset; and
in response to monitoring at least a threshold number of user interactions with a particular portion of the virtual representation of the tangible asset, preloading information associated with the particular portion of the virtual representation of the tangible asset to a computing device associated with the user during a subsequent user interaction with the plurality of portions of the virtual representation of the tangible asset.

15. A computing system comprising:
a memory; and
a processor configured to receive a visual representation of a tangible asset, wherein the processor is further configured to divide the visual representation of the tangible asset into a plurality of portions, wherein the processor is further configured to provide the plurality of portions of the visual representation of the tangible asset for display within a graphical user interface of at least one computing device, wherein the processor is further configured to receive, from the at least one computing device, a user selection of at least one portion of the plurality of portions of the visual representation of the tangible asset, and wherein the processor is further configured to associate the at least one selected portion of the visual representation of the tangible asset with the user.

16. The computing system of claim 15, wherein dividing the visual representation of the tangible asset into the plurality of portions includes dividing the visual representation of the tangible asset into a plurality of equal-sized portions.

17. The computing system of claim 16, wherein the plurality of equal-sized portions include a plurality of equal-sized units and a plurality of equal-sized sub-units associated with each equal-sized unit.

18. The computing system of claim 15, wherein dividing the visual representation of the tangible asset into the plurality of portions is based upon, at least in part, a value of the tangible asset.

19. The computing system of claim 15, wherein associating the at least one selected portion of the visual representation of the tangible asset with the user includes one or more of:
enabling the user to convey the at least one selected portion of the visual representation of the tangible asset to another user;
enabling the user to define a price for the at least one selected portion of the visual representation of the tangible asset; and
enabling a user to modify a visual appearance of the at least one selected portion of the visual representation of the tangible asset.

20. The computing system of claim 15, further comprising:
providing a visual indicator for the plurality of portions of the visual representation of the tangible asset indicative of whether each portion of the visual representation of the tangible asset is associated with any user.
